(19) United States
(12) Patent Application Publication
(10) Pub. No.: US 2020/0287317 A1
(43) Pub. Date: Sep. 10, 2020

(54) SUBSEA HIGH VOLTAGE CONNECTION ASSEMBLY

(71) Applicant: Benestad Solutions AS, Lierskogen (NO)

(72) Inventor: Johannes Arngrim VASSGÅRD, Rasta (NO)

(73) Assignee: Benestad Solutions AS, Lierskogen (NO)

(21) Appl. No.: 16/305,016

(22) PCT Filed: Jun. 2, 2017
(86) PCT No.: PCT/EP2017/063449

§ 371 Date: Nov. 27, 2018

(30) Foreign Application Priority Data
Jun. 3, 2016 (NO) 20160958

(51) Int. Cl. H01R 13/523; H01R 13/631; H01R 13/502

(52) U.S. Cl. CPC H01R 13/523; H01R 13/5025; H01R 13/6315

(57) ABSTRACT

A subsea HV connection assembly comprising a male part (101) with an axially movable male pin (106) with a electric contact face. The male pin is supported in a support (103). A female part (1) has a female contact face (25), a female housing (5) and a male pin receiving aperture (7). The female housing (5) or the support (103) is flexibly supported to a support section (15, 115) over a flexible support arrangement (9). The flexible support arrangement (9) comprises a pivoting member (11) with an outer pivot face (14) in sliding engagement with an inner pivot face (16), wherein the pivot faces have the shape of a section of a concentric sphere, wherein the pivoting member (11) is configured to pivot with respect to the inner pivot face (16) about a pivotal point (24).

The present invention relates to a subsea coupling arrangement for high voltage transmission. The connection assembly is of a wet-mate type, configured to connect and disconnect in a subsea environment.

### BACKGROUND

A number of challenges arise when designing such subsea high voltage connectors. In particular, as is well known to the skilled person, the combination of high voltage and conducting sea water puts high demands on the connection assembly. A challenge is to design a connection assembly which will function as intended after a long period of inactivity. For instance, such connectors may remain in a constant position for several years in a subsea environment, after which they need to function as intended.

A common setup for such connection assemblies is to mate a male and a female part. Typically, a male pin having an electric contact face is inserted into the female section until the contact face abuts an oppositely facing female contact face.

An example of such a subsea electrical connection assembly is shown in patent application publication WO2015199550. In this solution, a male and female part are aligned with respect to each other. Then, a male pin supported in the male part is inserted into the female part. The female part has a movable core arranged in a male pin receiving aperture, which is moved axially into the female part upon insertion of the male pin. A male pin contact face faces radially outwards at a front part of the male pin. In a receiving bore of the female part, a radially inwardly facing contact face abuts the male pin contact face, when in the inserted, connected position.

When designing such connection assemblies, it is an object to have small tolerances between the male pin and the bore of the female part, into which the male pin is inserted. Such small tolerances results in high demands for mutual alignment of the male and female parts, before the insertion of the male pin. Since, however, it is cumbersome to align the male and female parts within the small tolerances of the male pin and female bore, it is known to design some flexibility into the female and/or male part. In this manner, the two parts may self-align, when the male part engages the female part.

In said WO2015199550, the female part has a housing which is flexibly supported to a support structure. A flexible, elongated sleeve is interposed in an annulus between the female housing and the support structure, so that when the male part engages the female part, the female housing can align to the position of the male part.

Another typical example of such a subsea electric connection assembly is shown in FR2529396. When inserting the male pin, a movable core is pushed into the female part, letting radially facing contact electric contacts mate with opposite electric contacts in the female bore. The male pin is movably supported within a male housing which is aligned with a female housing before inserting the male pin. At a base end, the male housing is flexibly supported with elastic spacers and resilient sleeves. Thus, the entire male housing may pivot to some extend about its base end. Notably, in the solutions disclosed in FR2529396 and WO2015199550, when inserting the male pin, there will be some self-alignment between the male pin and the female bore.

In the known art, the design providing such self-alignment for electric high voltage connection assemblies of the type discussed above, is complex. It is an object of the present invention to provide a subsea high voltage connection assembly having such self-aligning features, which is less complex and yet efficient and reliable.

### THE INVENTION

According to the present invention, there is provided a subsea high voltage connection assembly comprising a male part with an axially movable male pin with a male electric contact face, wherein the male pin is supported in a male pin support. It further comprises a female part with a female electric contact face, a female housing and a male pin receiving aperture. The assembly also comprises a flexible support arrangement. The female housing or the male pin support is flexibly supported to a support section over the flexible support arrangement. The female part and the male part comprise mutually engaging alignment faces configured for mutual alignment of the female part and the male part. The flexible support arrangement comprises a pivoting member with an outer pivot face in sliding engagement with an opposite inner pivot face. The outer pivot face and the inner pivot face have the shape of a section of a concentric sphere, wherein the pivoting member is configured to pivot with respect to the inner pivot face about a pivotal point. The alignment face of the female part or the alignment face of the male part, respectively, is fixed with respect to the pivoting member.

It will be clear to the skilled reader that the said pivotal movement, about the pivotal point, can take place about any axes that extend perpendicularly with respect to an axially extending axis through the pivotal point. That is, the pivotal movement discussed herein does not relate to a mere rotation about the center axis of the inner pivot face.

Hence, the flexible support arrangement has the function of a ball joint, wherein a section of a concentric sphere is arranged to pivot within a receiving, opposite sphere-shaped support face. The female housing or the male pin support is thus able to pivot into an aligned pivotal orientation with respect to the opposite male part or female part, respectively. Such pivotal movement can be brought about when moving the male part into engagement with the female part, so that the alignment faces transfer alignment forces which will align the two parts with respect to each other.

With the term high voltage is herein meant voltages of 1 kV and above.

In some embodiments of the present invention, in which the flexible support arrangement is connected to the female part, the male electric contact face is configured to move past the pivotal point when the male pin is inserted from a non-inserted, non-connected position, into an inserted, connected position. Moreover, when in the inserted, connected position, the pivotal point can be positioned within the male pin.

In such embodiments, the pivotal point will be relatively close to the male part when the male and female parts are aligned. Such design facilitates a proper alignment.

Still with regards to such embodiments, among the alignment faces of the female part, there can be an inclined guiding face, an axial guiding face that faces radially inwards, and an end contact face, wherein the axial guiding face is arranged between the inclined guiding face and the end contact face. Advantageously, in such embodiments, the axial guiding face is closer to a center axis extending through the pivotal point, than the outer pivot face is.

The flexible support arrangement can further comprise a movable support member which is radially movable with respect to the support section. In such embodiments, the inner pivot face can be fixed with respect to the movable support member. Having such a movable support member which is radially movable, makes the female part or male part able to align in the radial direction, with respect to the opposite male part or female part, respectively.

Advantageously, the movable support member is axially fixed with respect to the support section. In such an embodiment, it may move only in the radial direction. Such embodiments may be provided by providing the movable support member with an axially facing sliding face which is configured to slide against an opposite fixed sliding face which is fixed with respect to the support section. In this respect, the term axially facing shall be construed with respect to the support section.

In embodiments where the flexible support arrangement is arranged in association with the female part, the support section can be connected to or can be a part of an outer housing of the female part. The female housing can then be configured to move inside the outer housing, as it can be flexibly connected to the outer housing over the flexible support arrangement.

In embodiments where the flexible support arrangement is arranged in association with the male part, when the male pin is in a retracted, non-connected position, the flexible support arrangement can advantageously be axially closer to the front face of the male pin than to the opposite end of the male pin.

### EXAMPLE OF EMBODIMENT

While various features of the present invention have been discussed in general terms above, a more detailed, non-limiting example of embodiment will be discussed in the following with reference to the drawings, in which

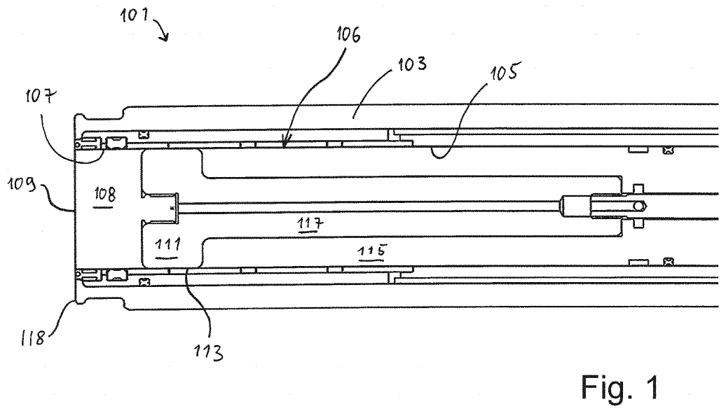

FIG. 1 is a cross section view through a male part of the connection assembly;

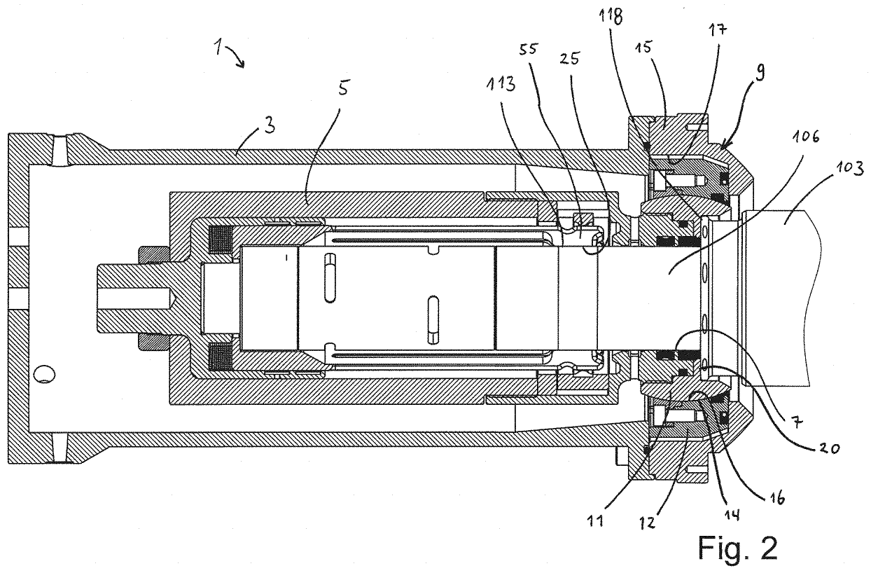

FIG. 2 is a cross section view through a female part, wherein a male pin has been inserted into female part, to a connected state;

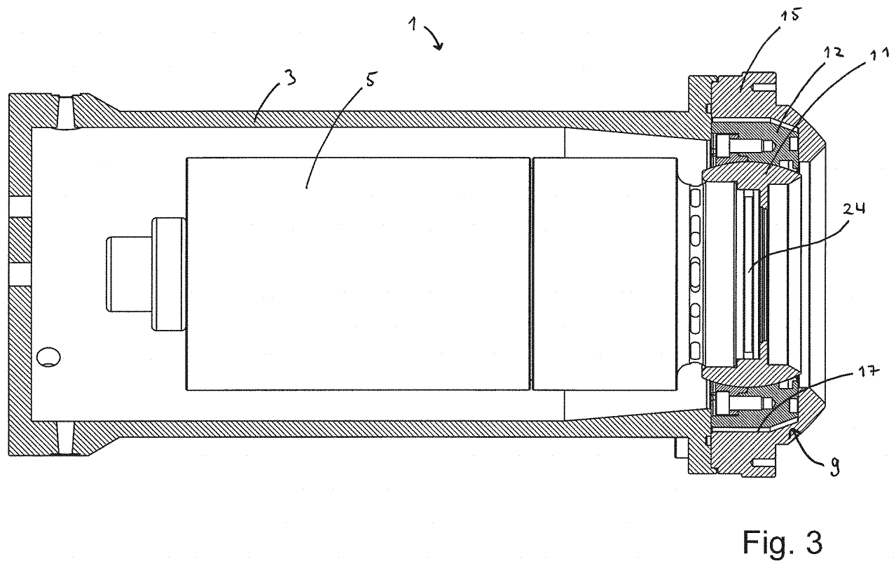

FIG. 3 is a cross section view, showing less details of the female part;

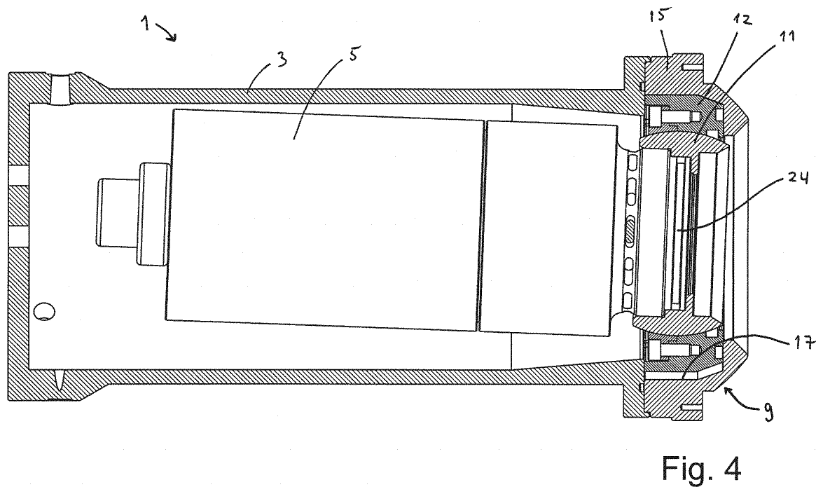

FIG. 4 is a cross section view corresponding to FIG. 4, however showing a female housing in an inclined orientation;

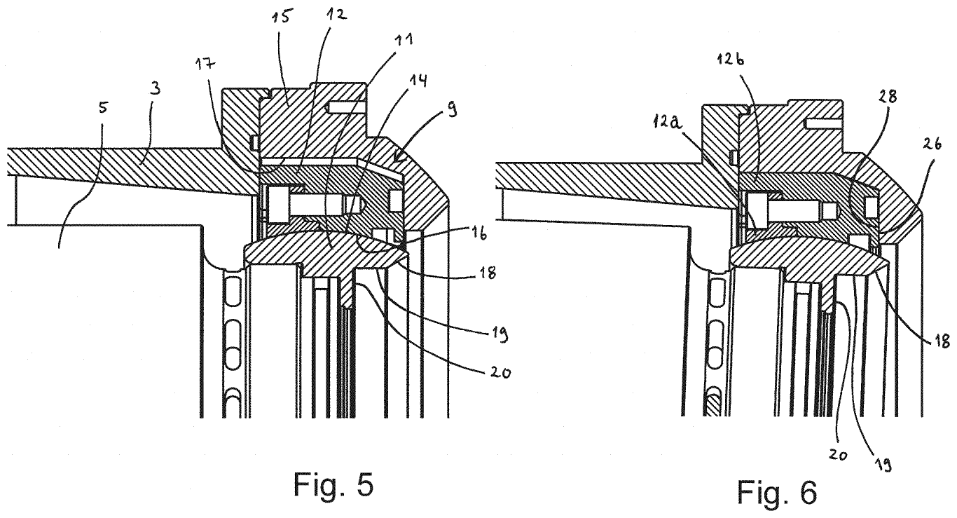

FIG. 5 is an enlarged cross section view of a flexible support arrangement;

FIG. 6 is another enlarged cross section view of the flexible support arrangement; and

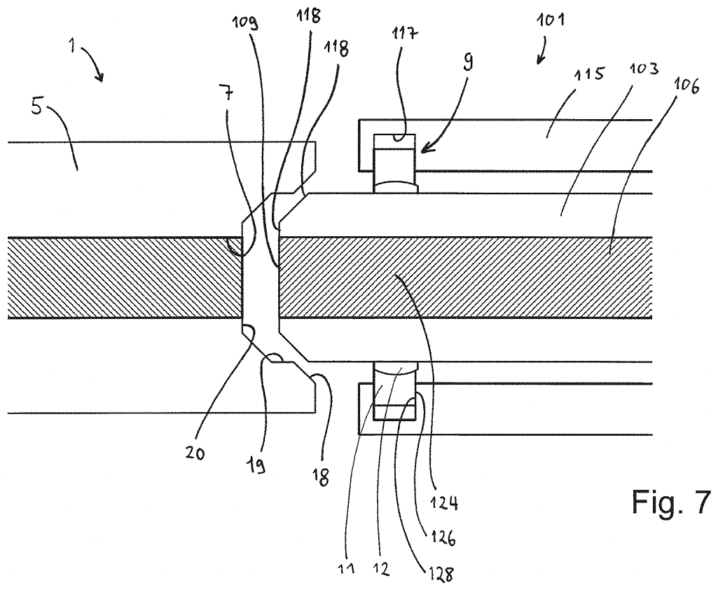

FIG. 7 is a schematic illustration of an alternative embodiment of the present invention.

Reference is made to FIG. 1 for a presentation of a male part 101 which is suited for being used with a female part 1 which will be discussed below. The male part 101 has a male housing 103 with an inner male bore 105. Within the male bore 105, there is arranged a male pin 106, which is axially movable, partially out from the male housing 103, through a male housing aperture 107.

The male pin 106 has a front portion 108 with a front face 109. The front portion 108 is made of an electrically insulating material. Axially behind the front portion 108, the male pin 106 has a conduction portion 111 with radially outwardly facing electric contact face 113. Axially behind the electric contact face 113, the male pin 106 has an insulating stem portion 115 which extends axially backwards. The conduction portion 111 is electrically connected to a stem conductor 117 inside the insulating stem portion 115.

When the male pin 106 is inserted into the female part 1 (discussed below) to a connected position, the electric contact face 113 of the male pin 106 is configured to contact an oppositely faced electric contact face 25 of the female part 1. This electric contact face 25 is shown in FIG. 2. In this embodiment, the electric contact face 25 is arranged on a radially movable actuation component 55. It should be clear however, that it could also be arranged on a radially fixed element, wherein the opposite electric contact faces 113, 25 would enter into contact with each other with a mutual sliding, axial movement. The male and female contact faces 113, 25 could also be facing in another direction than a radial direction. For instance, they could face in an axial direction, or even in an inclined direction.

FIG. 2 shows a cross section view through a female part 1 of a subsea high voltage connection assembly according to the present invention. In this embodiment, the female part 1 has two housings, namely an outer housing 3 and an inner, female housing 5. In other embodiments, there may be only one housing, for instance corresponding to the female housing 5 shown in FIG. 2. The female housing 5 has a male pin receiving aperture 7 at an axial outer end.

At the region of the male pin receiving aperture 7, the female housing 5 is engaged with the outer housing 3 via a flexible support arrangement 9. The flexible support arrangement 9 comprises a pivoting member 11 supported in a movable support member 12. As can be seen from the cross section view of FIG. 2, the pivoting member 11 has an outer pivot face 14 which abuts an opposite inner pivot face 16 of the movable support member 12. The outer pivot face 14 abuts the inner pivot face 16 in a sliding manner, so that the pivoting member 11 can pivot with respect to the movable support member 12. The shapes of the facing outer and inner pivot faces 14, 16 correspond to a circumferentially extending segment of a concentric sphere.

The movable support member 12 is supported in a fixed support section 15. In the shown embodiment, the fixed support section 15 constitutes an end section which is fixed to the outer housing 3. It shall be understood, however, that in other embodiments, the fixed support section 15 can be fixed to other structures, to which the female part 1 is attached.

The fixed support section 15 comprises a support cavity 17. The movable support member 12 is supported in the support cavity 17 in such manner that it may slide with respect to the fixed support section 15 in a radial direction. The movable support member 12 may however not pivot with respect to the fixed support section 15 as the pivoting member 11 can.

In FIG. 2, the female part 1 is shown in a connected mode. In this mode, the radially inwardly facing, electric contact face 25 of the female part 1 abuts the radially outwardly facing, electric contact face 113 of the male pin 106.

FIG. 2 depicts various components of the female part 1 which are not relevant for the topic of the present invention, and which therefore will not be discussed in detail herein.

Reference is now made to FIG. 3 and to FIG. 4, which depict the female part separate from the male part for illustrational purpose. Also for illustrational purpose, the female housing 5 is shown in a side view instead of a cross section view. A comparison of FIG. 3 and FIG. 4 illustrates how the female housing 5, which is supported with the pivoting member 11, is able to pivot with respect to the fixed support section 15. Also shown is how the pivoting member 11, and hence the female housing 5, can be radially displaced with respect to the fixed support section 15. When pivoting with respect to the fixed support section 15, the pivoting member 11 will pivot about a pivotal point 24.

The skilled person will now appreciate that when the male part 101 (not shown in FIG. 3 and FIG. 4) is engaged with the female part 1, the female housing 5 will adapt to a misalignment between the male part 101 and the female part 1. Also, when inserting the male pin 106 into the female part 1, from a non-connected, non-inserted position, to a connected, inserted position, the male pin 106 will move past the pivotal point 24. In this embodiment, the pivotal point is positioned axially outside the axial position of the female electric contact faces 25 (cf. FIG. 2).

To illustrate the function and design of the flexible support arrangement 9 in better detail, reference is made to FIG. 5 and FIG. 6. The enlarged sections of FIG. 5 and FIG. 6 correspond to the drawings of FIG. 3 and FIG. 4, respectively.

For mutual alignment of the female part 1 and the male part 101, they are provided with alignment faces which are configured to result in such mutual alignment when the two parts are moved together into an engaged position. The pivoting member 11 has an inclined guiding face 18 which may abut against a male contact face 118 of the male housing 103 (cf. FIG. 1) when the male part 101 is moved into engagement with the female part 1. That is, if there is a radial misalignment between the male housing 103 and the pivoting member 11, a sliding engagement between the male contact face 118 and the inclined guiding face 18 will provide radial alignment. The said engagement will move the pivoting member 11 and the movable support member 12 radially with respect to the fixed support section 15. A comparison of FIG. 5 and FIG. 6 (see also FIG. 3 and FIG. 4) reveals that the movable support member 12 has moved radially upwards in the support cavity 17 of the fixed support section 15, in this example.

It will be clear to the skilled person that in other embodiments, one could arrange an inclined guiding face on the male part 101, such as on the male housing 103, instead of or in addition to on the female part 1.

When the male contact face 118 of the male housing 103 abuts an opposite end contact face 20 of the pivoting member 11, an angular misalignment between the male housing 103 and the pivoting member 11 will be corrected by a pivoting movement of the pivoting member 11. FIG. 2 depicts a situation where the male contact face 118 is in engagement with the end contact face 20 of the pivoting member 11.

In the discussed embodiment, the end contact face 20 has a circular, and strictly radial extension (axially facing). It is adapted to engage the front of the male contact face 118 of the male part 101 (male housing 103). It will be clear to the skilled person however, that other embodiments may involve an end contact face having another design. It may for instance not be a continuous, circular face. It may also deviate from the strict radial extension shown herein, depending on the design of the male contact face 118. The functional purpose of the end contact face 20 of the female part 1 is to halt the mutual, engaging movement between the female and male parts 1, 101 when they are brought together and into alignment.

On the female part 1, between the inclined guiding face 18 and the end contact face 20, there is arranged a radially inwardly facing axial guiding face 19. The axial guiding face 19 is configured to guide the male part 101, or more precisely, the male contact face 118 on the male housing 103, in an axial direction until abutment with the end contact face 20. Notably, the position of the axial guiding face 19 is closer to a center axis (not shown) extending through the pivotal point 24 (cf. FIG. 3 and FIG. 4) than the outer pivot face 14 is.

The movable support member 12 comprises an inner ring 12a and an outer ring 12b, which are secured together when positioned on the outer pivot face 14 of the pivoting member 11, for instance by bolts (cf. FIG. 6).

In FIG. 6 there is indicated a sliding face 26 on the movable support member 12. The sliding face 26 extends in a radial direction, hence facing in an axial direction. The sliding face 26 abuts and is configured to slide against an opposite fixed sliding face 28 on the fixed support section 15. It will be understood that the two sliding faces 26, 28 can also be arranged on intermediate elements that are fixed to the movable support member 12 and the fixed support section 15, respectively. In the shown embodiment, the fixed sliding face 28 constitutes a part of the support cavity 17 formed in the fixed support section 15. Notably, the support cavity has a diameter which is larger than the diameter of the movable support member 12 arranged within it, so that the movable support member 12 may move in the radial direction.

The skilled person will appreciate that electric conduction is provided to the female electric contact face 25 in the female part 1, such as with electric cables (not shown) arranged at the rear portion (left hand side of FIG. 2) of the female part 1. This also applies to the male part 101.

It will also be clear to the skilled person, that although the electric contact faces 25, 113 of the shown embodiment face in a radial direction, the invention also relates to connection assemblies having other types of contact faces. Thus, in other embodiments the contact faces of the male and female parts may for instance be axially facing.

The skilled person in this field will also appreciate that seals should be used at appropriate locations, as is a well-known practice in this art.

FIG. 7 depicts, with a principle view, an alternative embodiment of the invention. Here, the flexible support arrangement 9 is arranged on the male part 101. The male pin 106 is supported in a male pin support, here in the form of a male housing 103, which is flexibly supported to a male support section 115. Hence, when the male part 101 and the female part 1 are brought together, radial and pivotal alignment will occur with the male housing 103 and the male pin 106 inside it. The pivotal point 124 is now in the male part 101.

The function of the flexible support arrangement 9 shown in FIG. 7 corresponds to that shown and discussed with reference to the previous drawings.

1. A subsea high voltage connection assembly comprising
a male part with an axially movable male pin with a male electric contact face, wherein the male pin is supported in a male pin support;
a female part with a female electric contact face, a female housing and a male pin receiving aperture;
a flexible support arrangement;
wherein the female housing or the male pin support is flexibly supported to a support section over the flexible support arrangement, wherein the female part and the male part comprise mutually engaging alignment faces configured for mutual alignment of the female part and the male part;
wherein the flexible support arrangement comprises a pivoting member with an outer pivot face in sliding engagement with an opposite inner pivot face, wherein the outer pivot face and the inner pivot face have the shape of a section of a concentric sphere, wherein the pivoting member is configured to pivot with respect to the inner pivot face about a pivotal point; and
wherein the alignment face of the female part or the alignment face of the male part, respectively, is fixed with respect to the pivoting member.

2. The subsea high voltage connection assembly according to claim 1, wherein the flexible support arrangement is part of the female part and that the male electric contact face is configured to move past the pivotal point when the male pin is inserted from a non-inserted, non-connected position, into an inserted, connected position, and that when in the inserted, connected position, the pivotal point is positioned within the male pin.

3. The subsea high voltage connection assembly according to claim 2, wherein among the alignment faces of the female part, there is an inclined guiding face, an axial guiding face facing radially inwards, and an end contact face, wherein the axial guiding face is arranged between the inclined guiding face and the end contact face, and wherein the axial guiding face is closer to a center axis extending through the pivotal point, than what the outer pivot face is.

4. The subsea high voltage connection assembly according to claim 1, wherein the flexible support arrangement further comprises a movable support member which is radially movable with respect to the support section, and that the inner pivot face is fixed with respect to the movable support member.

5. The subsea high voltage connection assembly according to claim 4, wherein the movable support member comprises an axially facing sliding face which is configured to slide against an opposite fixed sliding face which is fixed with respect to the support section.

6. The subsea high voltage connection assembly according to claim 3, wherein the support section is connected to or is a part of an outer housing of the female part, wherein the female housing is configured to move inside the outer housing, as it is flexibly connected to the outer housing over the flexible support arrangement.

7. The subsea high voltage connection assembly according to claim 1, wherein the flexible support arrangement is part of the male part and that when the male pin is in a retracted, non-connected position, the flexible support arrangement is axially closer to the front face of the male pin than to the opposite end of the male pin.
